(19) United States
(12) Patent Application Publication
(10) Pub. No.: US 2026/0135699 A1
(43) Pub. Date: May 14, 2026

(54) SYSTEM AND METHOD FOR SECURE DATA SHARING WITH DYNAMIC KEY GENERATION

(71) Applicants: Milind Madhukar DEORE, Pune (IN); Ashish GUPTA, Bangalore (IN); Arya Shekhar PATIL, Bangalore (IN)

(72) Inventors: Milind Madhukar DEORE, Pune (IN); Ashish GUPTA, Bangalore (IN); Arya Shekhar PATIL, Bangalore (IN)

(21) Appl. No.: 19/096,386

(22) Filed: Mar. 31, 2025

(30) Foreign Application Priority Data
Nov. 12, 2024 (IN) 202421087219

(51) Int. Cl. H04L 9/08; G06F 21/60

(52) U.S. Cl. CPC H04L 9/0869; G06F 21/604; H04L 9/085

(57) ABSTRACT

A system for secure data encryption and decryption is described. A transmitter dynamically selects cryptographic materials and techniques along with a randomly generated shared key. By using selected cryptographic materials, techniques, and the shared key, the transmitter generates a dynamic key and configures attributes for data. The transmitter encrypts the data with a symmetric key derived from the dynamic and shared keys and transmits the encrypted data to a receiver. Upon receiving the data, the receiver identifies the cryptographic material, technique, and shared key used, generates a dynamic key, and determines a symmetric key. The receiver decrypts the data using the symmetric key and retrieves data attributes, enabling secure and controlled data sharing.

### CROSS REFERENCE TO RELATED APPLICATIONS

This application claims the benefit of Indian Patent App. No. 202421087219, filed Nov. 12, 2024, the disclosure of which is hereby incorporated by reference herein.

### TECHNICAL FIELD

The present disclosure relates to secure data sharing, and more particularly to a method and a system that enables data transmitters to maintain control over shared data through dynamic cryptographic materials and cryptographic techniques to enhance data security.

### BACKGROUND

In the current digital landscape, secure communication between parties has become increasingly critical. End-to-end encryption over the Internet has emerged as a primary method for ensuring that messages and data remain inaccessible to unauthorized third parties during transmission between devices or systems. This approach has been widely adopted by messaging applications and communication tools to facilitate secure message transmission.

End-to-end encryption protocols typically ensure that messages remain encrypted until they reach to device of intended recipient and are displayed on their screen. Once the message is successfully delivered and decrypted, the encryption protocol concludes its role. Advanced protocols incorporate features such as forward secrecy and future secrecy to further enhance security. Forward secrecy aims to prevent compromise of past communications even if current keys are compromised, while the future secrecy seeks to maintain security of future communications in the event of a key compromise.

Despite these advancements, challenges persist in securing personal and business data. While data in transit and at rest may be effectively safeguarded, control over shared data becomes problematic once it reaches the recipient. At this point, the data is often converted to a readable or usable format, leaving it at the discretion of the recipient to manage. This situation may result in the original data owner losing control over their shared information.

The proliferation of unstructured data in modern computing environments has further complicated data control efforts. There is a growing need to minimize reliance on intermediaries, middlemen, and third-party applications for accessing personal and business data while ensuring that the data remains opaque to these entities.

Current solutions generally do not provide mechanisms for data owners to maintain control over their information after it has been shared and decrypted by recipients. This limitation may lead to unauthorized redistribution, modification, or misuse of sensitive data. Additionally, the data owners may lack visibility into where and with whom their data is being shared beyond the initial recipient.

Thus, as the volume and sensitivity of digital information continue to grow, there is a need for more robust and flexible data protection solutions that may provide data owners with greater control over their shared information, even after it has been transmitted and decrypted while maintaining the security benefits of the end-to-end encryption.

### OBJECTS OF THE PRESENT DISCLOSURE

An object of the present disclosure is to provide a system and method for secure data sharing and control that addresses security concerns.

An object of the present disclosure is to maintain data in an encrypted format throughout an entire lifecycle, from creation to sharing and storage, ensuring continuous protection of sensitive information.

Another object of the present disclosure is to dynamically select encryption and decryption keys without direct exchange between parties, enhancing security and eliminating the need for key storage or transmission.

Another object of the present disclosure is to provide data owners with persistent control over shared information, even after it has been transmitted to recipients, allowing the transmitter for granular access management and revocation.

Yet another object of the present disclosure is to enable flexible access controls, including the ability to set time limits on data access, restrict downloading, forwarding, and screenshot capture, and revoke access remotely.

Yet another object of the present disclosure is to minimize reliance on intermediaries and third-party applications for data access and management, reducing potential security and privacy risks.

Yet another object of the present disclosure is to ensure data remains opaque to any third-party services involved in transmission or storage, preserving confidentiality throughout the data-sharing process.

Yet another object of the present disclosure is to provide enhanced visibility to data owners regarding the location and usage of their shared information, improving transparency and control.

### SUMMARY

Aspects of the present disclosure generally relate to systems and methods for secure data encryption and decryption. More particularly, the present disclosure relates to a system and a method that enables data transmitter to maintain control over shared data through dynamic cryptographic materials and cryptographic techniques to enhance data security.

In an aspect, a transmitter for data encryption includes one or more processors and a memory operatively coupled to the one or more processors. The memory includes processor-executable instructions, which, when executed, cause the one or more processors to dynamically select at least one cryptographic material from a plurality of cryptographic materials and at least one cryptographic technique from a plurality of cryptographic techniques. Further, the one or more processors generate a dynamic key using the at least one cryptographic material, the at least one cryptographic technique. Furthermore, the one or more processors randomly generate a shared key. Further, the one or more processors determine a symmetric key based on the dynamic key and shared key. Furthermore, the one or more processors configure one or more attributes for data. Further, the one or more processors encrypt the data using the symmetric key after the configuration and transmit the encrypted data to one or more receivers.

In an embodiment, the one or more processors are further configured to transmit the plurality of cryptographic materials and the plurality of cryptographic techniques to the one or more receivers through one or more pre-established channels and receive the plurality of cryptographic materials and the plurality of cryptographic techniques from the one or more receivers through the one or more pre-established channels. Further, the one or more processors are further configured to dynamically select the at least one cryptographic material and the at least one cryptographic technique upon the reception and the transmission of the plurality of cryptographic materials and the plurality of cryptographic techniques is completed.

In an embodiment, the one or more attributes for the data includes at least one of: option for enabling or disabling download, option for permitting or blocking the data to share with another one or more receivers, options for permitting or blocking snapshots of the data, time-based data revocation.

In an embodiment, the one or more processors are further configured to generate a hash value associated with the data and transmit the hash value along with the encrypted data to the one or more receivers.

In an embodiment, the one or more processors are further configured to transmit an identifier associated with the at least one cryptographic material and the at least one cryptographic techniques along with the encrypted data to the one or more receivers.

In an embodiment, the one or more processors are further configured to remove the at least one cryptographic material, the at least one cryptographic technique, and the shared key associated with the data to restrict the one or more receivers from accessing the data.

In an embodiment, the one or more processors are configured to receive a request message from the one or more receiver and transmit the shared key to the one or more receivers in response to the reception of the request message.

In another aspect, a receiver for data decryption includes one or more processors and a memory operatively coupled to the one or more processors. The memory includes processor-executable instructions, which, when executed, cause the one or more processors to receive data from one or more transmitters and determine that the data are encrypted with at least one cryptographic material, at least one cryptographic technique, and a shared key. Further, the one or more processors determine an identifier associated with the at least one cryptographic material and the at least one cryptographic technique. The one or more processors further generate a dynamic key using the at least one cryptographic technique based on information associated with the at least one cryptographic material. Further, the one or more processors determine a symmetric key based on the dynamic key and the shared key and decrypt the encrypted data using the symmetric key to determine one or more attributes associated with the data.

In an embodiment, the one or more processors are further configured to transmit the plurality of cryptographic materials and the plurality of cryptographic techniques to the one or more transmitters through one or more pre-established channels and receive the plurality of cryptographic materials and the plurality of cryptographic techniques from the one or more transmitters through the one or more pre-established channels. Further, the one or more processors are further configured to determine that the reception and the transmission of the plurality of cryptographic materials and the plurality of cryptographic techniques are completed and receive the data from the one or more transmitters based on the determination of the reception and the transmission.

In an embodiment, the one or more processors are further configured to generate a hash value associated with the data and compare the generated hash value with the hash value received from the one or more transmitters for validation.

In an embodiment, the one or more processors are configured to transmit a request message to the one or more transmitters and receive the shared key in response to the transmission of the request message for decrypting the data

In another aspect, a method for data encryption includes dynamically selecting, by one or more processors, at least one cryptographic material from a plurality of cryptographic materials and at least one cryptographic technique from a plurality of cryptographic techniques. Further the method includes generating, by the one or more processors, a dynamic key using the at least one cryptographic material, the at least one cryptographic technique. The method further includes randomly generating, by the one or more processors, a shared key and determining, by the one or more processors, a symmetric key based on the dynamic key and the shared key. Further, the method includes configuring, by the one or more processors, attributes for data. The method further includes encrypting, by the one or more processors, the data using the symmetric key. Furthermore, the method includes transmitting, by the one or more processors, the encrypted data to one or more receivers.

In another aspect, a method for data decryption includes receiving, by the one or more processors, encrypted data from one or more transmitters. Further the method includes, by the one or more processors, determining that the data are encrypted associated cryptographic material, technique. Furthermore, the method includes generating, by the one or more processors, a dynamic key using the at least one cryptographic technique based on information associated with the at least one cryptographic material based on the determination of the identifier. Further, the method includes, determining by the one or processor, a symmetric key based on the dynamic key and the shared key. The method further includes decrypting, by the one or more processors, the data using the symmetric key to determine one or more attributes associated with the data.

Various objects, features, aspects, and advantages of the inventive subject matter will become more apparent from the following detailed description of preferred embodiments, along with the accompanying drawing figures in which like numerals represent components.

### BRIEF DESCRIPTION OF THE DRAWINGS

The accompanying drawings are included to provide a further understanding of the present disclosure and are incorporated in and constitute a part of this specification. The drawings illustrate example embodiments of the present disclosure and, together with the description, serve to explain the principles of the present disclosure.

The accompanying drawings are included to provide a further understanding of the present disclosure and are incorporated in and constitute a part of this specification. The drawings illustrate example embodiments of the present disclosure and, together with the description, serve to explain the principles of the present disclosure.

FIG. 1 illustrates an example network architecture for implementing a system for secure encryption and decryption, in accordance with an embodiment of the present disclosure.

FIG. 2A illustrates an exemplary block diagram of a transmitter for data encryption, in accordance with an embodiment of the present disclosure.

FIG. 2B illustrates exemplary block diagram of a receiver for data decryption, in accordance with an embodiment of the present disclosure.

FIG. 3 illustrates a flow diagram of an exemplary method for secure data encryption and sharing the encrypted data to the receiver, in accordance with an embodiment of the present disclosure.

FIG. 4 illustrates a flow diagram of an exemplary method for decrypting the data received from the transmitter, in accordance with an embodiment of the present disclosure.

FIG. 5 illustrates an exemplary representation of a structure of outgoing data from the transmitter to the receiver, according to an embodiment of the present disclosure.

FIG. 6A illustrates a flow diagram illustrating an exemplary method for data encryption, in accordance with an embodiment of the present disclosure.

FIG. 6B illustrates a flow diagram illustrating an exemplary method for data decryption, in accordance with an embodiment of the present disclosure.

FIG. 7 illustrates an exemplary computer system in which or with which embodiments of each of the transmitter for data encryption and the receiver for data decryption system may be implemented, according to embodiments of the present disclosure.

### DETAILED DESCRIPTION

The following is a detailed description of embodiments of the disclosure depicted in the accompanying drawings. The embodiments are in such details as to clearly communicate the disclosure. However, the amount of detail offered is not intended to limit the anticipated variations of embodiments; on the contrary, the intention is to cover all modifications, equivalents, and alternatives falling within the scope of the present disclosures as defined by the appended claims.

Embodiments explained herein relate to the field of secure data encryption and decryption. The present disclosure provides a system and a method that uses dynamic cryptographic material and cryptographic techniques for enhanced data security.

An aspect of the present disclosure pertains to a transmitter for encrypting data. The transmitter dynamically selects at least one cryptographic material from a plurality of cryptographic materials and at least one cryptographic technique from a plurality of cryptographic techniques. The transmitter further generates a dynamic key using the at least one cryptographic material, the at least one cryptographic techniques, and the shared key. The transmitter randomly generates a shared key. The transmitter further determines a symmetric key based on the dynamic key and the shared key. The transmitter further configures one or more attributes for data. The transmitter encrypts the data using the symmetric key after the configuration and transmits the encrypted data to the one or more receivers. Another aspect of the present disclosure pertains to a receiver for data decryption. The receiver receives data from one or more transmitters. The receiver further determines that the data is encrypted with at least one cryptographic material of a plurality of cryptographic materials, at least one cryptographic technique of a plurality of cryptographic techniques and a shared key. The receiver determines an identifier associated with the at least one cryptographic material and the at least one cryptographic technique. The receiver generates a dynamic key using the at least one cryptographic technique based on information associated with the at least one cryptographic material by determining the identifier. The receiver determines a symmetric key based on the dynamic key and the shared key. The receiver determines one or more attributes associated with the data by decrypting the data using the symmetric key.

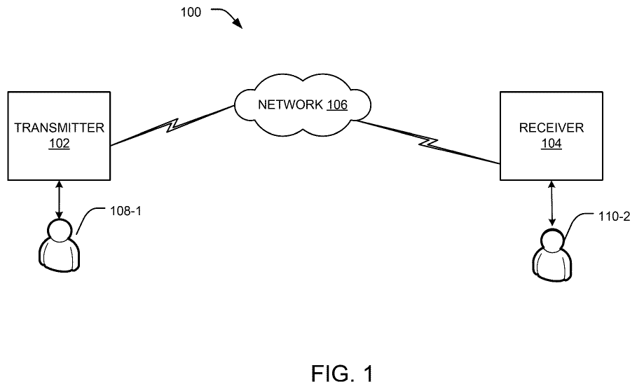

Various embodiments of the present disclosure will be explained in detail with reference to FIGS. 1-7.

FIG. 1 illustrates an example network architecture 100 for implementing system for secure encryption and decryption, in accordance with an embodiment of the present disclosure. A transmitter 102 may be communicatively coupled to a receiver 104 via a network 106. In an example, the network 106 may include, but is not limited to, a local area network (LAN), a Wide Area Network (WAN), Internet, a wireless network, a cellular network, or any combination thereof. The transmitter 102 and the receiver 104 may include one or more computing devices, such as servers, personal computers, laptops, smartphones, or other suitable devices capable of executing the secure data sharing and access methods described herein.

In an embodiment, the transmitter 102 may correspond to a first computing device (User Equipment (UE)) operated by a first user 108-1. The receiver 104 may correspond to a second computing device used by a second user 108-2. In an example, the computing devices may include various computer-enabled devices, such as laptops, smartphones, tablets, or other similar devices. In an example, the first user 108-1 may be the owner of data that is to be shared. In another example, the second user 108-2 may be receiver of the data.

In an embodiment, the first user 108-1 may initiate the encryption process through the transmitter 102. The transmitter 102 may dynamically generate a dynamic key to encrypt the data using the symmetric key. The transmitter 102 may determine a symmetric key based on both the dynamic and the shared key. The transmitter 102 configures one or more attributes for the data that is to be shared before encryption. The transmitter 102 may then transmit the encrypted data to the one or more receivers, such as the receiver 104.

In an embodiment, the encrypted data may be transmitted from the transmitter 102 to the receiver 104 via the network 106. The second user 108-2 may access the receiver 104 to receive the encrypted data from one or more transmitters, such as the transmitter 102. The receiver 104 may further determine whether the data is encrypted with at least one cryptographic material, at least one cryptographic technique, and a shared key. Furthermore, the receiver 104 may determine an identifier associated with the at least one cryptographic material and the at least one cryptographic technique. The receiver 104 may generate a dynamic key using the at least one cryptographic technique based on information associated with the at least one cryptographic material based on the determination of the identifier. The receiver 104 may determine a symmetric key based on the dynamic key and the shared key. The receiver 104 may then determine one or more attributes associated with the data by decrypting the data using the symmetric key.

The network architecture 100 enables secure data sharing between the first user 108-1 and the second user 108-2 while maintaining data owner control. The transmitter 102 and receiver 104 work in tandem to ensure that the data remains encrypted during transmission over the network 106 and may only be decrypted by the intended recipient using the proper key cryptographic material and technique processes.

Although FIG. 1 depicts specific components of the network architecture 100, in other embodiments, the system may include additional components or variations in the arrangement and function of the components to suit different security requirements or computing environments.

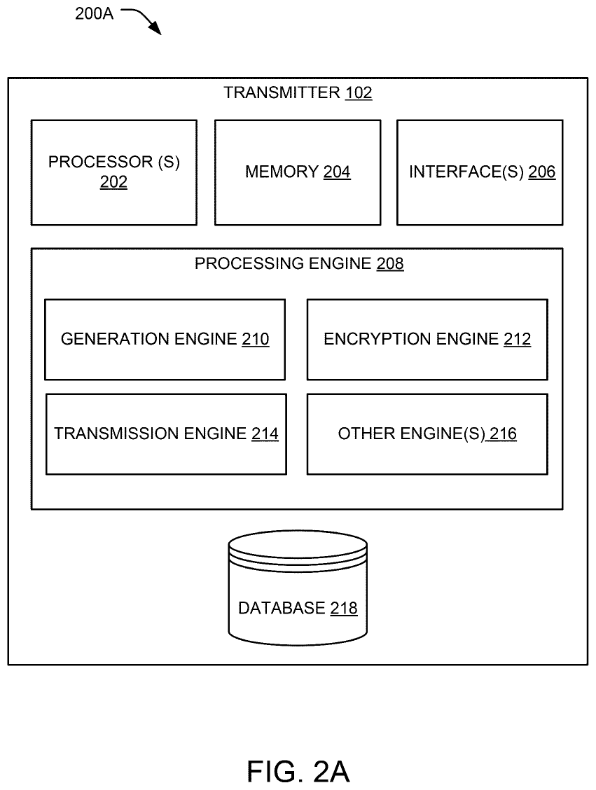

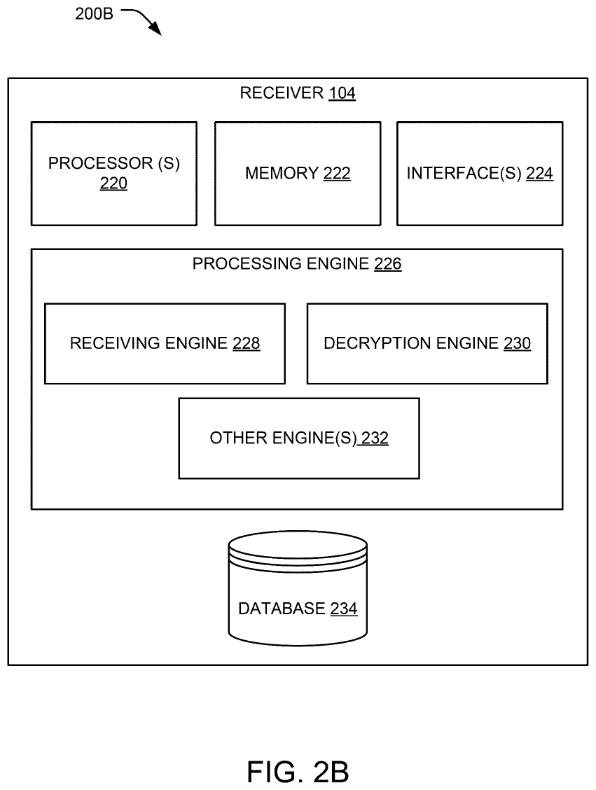

FIG. 2A illustrates an exemplary block diagram of the transmitter 102 for data encryption, in accordance with an embodiment of the present disclosure.

Referring to block diagram 200A of FIG. 2A, the transmitter 102 may include one or more processor(s) 202. The one or more processor(s) 202 may be implemented as one or more microprocessors, microcomputers, microcontrollers, digital signal processors, central processing units, logic circuitries, and/or any devices that manipulate data based on operational instructions. Among other capabilities, the one or more processor(s) 202 may be configured to fetch and execute computer-readable instructions stored in a memory 204. The memory 204 may store one or more computer-readable instructions or routines, which may be fetched and executed to create or share the data over a communication network, such as the network 106. The memory 204 may include any non-transitory storage device including, for example, volatile memory such as Random Access Memory (RAM), or non-volatile memory such as an Erasable Programmable Read-Only Memory (EPROM), flash memory, and the like.

In an embodiment, the transmitter 102 may also include an interface(s) 206. The interface(s) 206 may include a variety of interfaces, for example, interfaces for data input and output devices, referred to as Input/Output (I/O) devices, storage devices, and the like. The interface(s) 206 may also provide a communication pathway for one or more components of the transmitter 102. Examples of such components include, but are not limited to, processing engine(s) 208 and a database 218. In some embodiments, the database 218 may store therein data generated or received by the transmitter 102. For example, if the transmitter 102 is a server, the database 218 may be configured to store the plurality of cryptographic materials, the plurality of cryptographic techniques, the shared key, and data. The database 218 may also store user information, access logs, and other relevant data for the secure data sharing process. For example, if the transmitter 102 is the computing device, the memory 204 may be configured to store the plurality of cryptographic materials, the plurality of cryptographic techniques, the shared key, and data.

In an embodiment, the processing engine(s) 208 may be implemented as a combination of hardware and programming (for example, programmable instructions) to implement one or more functionalities of the first processing engine(s) 208. In the examples described herein, such combinations of hardware and programming may be implemented in several different ways. For example, the programming for the first processing engine(s) 208 may be processor-executable instructions stored on a non-transitory machine-readable storage medium and the hardware for the first processing engine(s) 208 may include a processing resource (for example, one or more processors), to execute such instructions. In other embodiments, the processing engine(s) 208 may be implemented by electronic circuitry. The database 218 may include data that is either stored or generated as a result of functionalities implemented by any of the components of the processing engine(s) 208.

In an embodiment, the processing engine(s) 208 may include a generation engine 210, an encryption engine 212, a transmission engine 214, and other engine(s) 216. The other engine(s) 216 may implement functionalities that supplement applications/functions performed by the transmitter 102.

In an embodiment, the one or more processors 202 may transmit the plurality of cryptographic materials and the plurality of cryptographic techniques to the receiver 104 through pre-established channels and receive the plurality of cryptographic materials and the plurality of cryptographic techniques from the receiver 104 through the pre-established channels. Further, the one or more processors 202 may dynamically select the at least one cryptographic material and the at least one cryptographic technique upon the reception and the transmission of the plurality of cryptographic materials and the plurality of cryptographic techniques is completed. In exemplary embodiments, before transmitting any encrypted data (BLOB), the transmitter and receiver exchange the Key Generation Materials (KGMs) and Key Derivation Functions (KDFs) in advance, ensuring the transmitter 102 and the receiver 104 have the necessary key materials readily available. The exchange is typically a one-time activity or occurs only when there is an update to the KGMs and KDFs. Since the exchange process is slow and does not happen frequently, it is carried out over a secure connection exclusively between the transmitter 102 and receiver 104.

In an embodiment, the generation engine 210 may be configured to dynamically select a cryptographic material from the plurality of cryptographic materials and the at least one cryptographic technique from the plurality of cryptographic techniques. In an example, the generation engine 210 may utilize a Key Generation Material (KGM) to dynamically select the cryptographic materials. In an example, the KGM may take various inputs such as random seeds, system parameters, or user-specific data to produce unique cryptographic materials for each encryption process. The KGM may include, but is not limited to, images, documents, text messages, Non-Fungible Tokens (NFTs), audio files, video files, or any other suitable digital content. In an embodiment, the generation engine 210 may dynamically create the cryptographic technique by employing a Key Derivation Function (KDF) (e.g., the cryptographic techniques) as the core component.

In an embodiment, the generation engine 210 may generate a dynamic key using the at least one cryptographic material, the at least one cryptographic techniques, and the shared key. This dynamic key may be a temporary encryption key generated for a single use, enhancing the security of the encryption process.

In an example, to generate the dynamic key, the generation engine 210 may employ KDFs. The KDFs may produce the dynamic key using the KGMs as input. In an example, the KGMs may include a diverse set of digital assets utilized for crafting the dynamic key. As explained previously, these digital assets may include, but are not limited to images (e.g., personal photographs, digital art), documents (e.g., PDFs, spreadsheets), text messages exchanged exclusively between the transmitter 102 and the receiver 104, NFTs, audio files, video clips, blockchain transaction hashes, geolocation data, biometric data (e.g., fingerprint or retina scan hashes), timestamps or other time-based data, and the like. In some embodiments, multiple KGMs may be used in combination to generate the dynamic key, enhancing its complexity and security. The selection and order of KGMs may be determined dynamically or according to a predefined protocol.

In an example, the files or digital assets utilized for crafting the dynamic key may be unique to either the transmitter 102 or the receiver 104, but not necessarily to both. For example, the transmitter 102 may use a personal image as part of their KGM, while the receiver 104 uses a different personal document. This asymmetry in KGMs may add an additional layer of security, as it requires both parties to maintain their unique set of materials for successful key generation and subsequent decryption. The generation engine 210 may process these KGMs through the selected KDF, along with the shared key and any additional parameters specified by the chosen cryptographic technique, resulting in a dynamic key. This dynamic key, combined with the shared key, is then used to derive a symmetric key. The symmetric key is unique to each encryption instance, highly unpredictable, and tightly bound to the specific context of the data exchange between transmitter 102 and receiver 104, ensuring secure and context-specific encryption.

In an embodiment, the generation engine 210 may randomly generate a shared key. In an example, the generation engine 210 may generate the shared key through a collaborative process involving multiple authorized peers. Each peer may contribute a unique piece of cryptographic information, which may be securely combined using multi-party computation. This combined input seeds a cryptographically secure random number generator to produce a high-entropy shared key for the KDF. The generation engine 210 may optionally split this key into shares using a secret sharing scheme and distribute them among peers. This ensures that the shared key may only be reconstructed and used when all necessary peers cooperate, for example, by using their secret key. This may prevent any single entity from independently generating or accessing the shared key.

In an embodiment, the encryption engine 212 may configure one or more attributes for the data that is to be shared with the receiver 104. In an example, the one or more attributes may include, but are not limited to, options for enabling or disabling download, options for permitting or blocking the data to share with another one or more receivers, options for permitting or blocking snapshots of the data, time-based data revocation.

In an embodiment, the encryption engine 212 may encrypt the data using the symmetric key after the configuration. In an example, the encryption engine 212 may configure various attributes for the data to be shared, including options for download control, sharing restrictions, screenshot prevention, and time-based revocation, along with additional security features like geolocation-based access, device-specific controls, and data expiration. After configuration, the encryption engine 212 encrypts the data using the symmetric key through a comprehensive process. This process may involve preparing and serializing the data, generating a unique initialization vector, embedding configured attributes in metadata, applying symmetric encryption, incorporating necessary parameters, generating integrity checks, and packaging everything into a secure container format, such as a blob.

In an embodiment, the encryption engine 212 may generate a hash value associated with the data. In an example, the hash value may be understood as a fixed-size string of characters generated by applying a cryptographic hash function to the original data. This hash value serves as a unique digital fingerprint of the data. In an example, the encryption engine 212 may generate this hash value using a secure cryptographic hash function, which produces a fixed-length output regardless of the input size.

In an example, the encryption engine 212 may further generate an identifier associated with the at least one cryptographic material and the at least one cryptographic technique. In an example, the identifier may be understood as a unique reference code or tag that encapsulates information about the specific cryptographic elements used in the encryption process.

In an embodiment, the transmission engine 214 may transmit the identifier associated with the at least one cryptographic material and the at least one cryptographic technique along with the encrypted data to the one or more receiver, such as the receiver 104. The transmission engine 214 may also transmit the hash value along with the encrypted data and the identifier.

In an embodiment, the transmission engine 214 may remove the at least one cryptographic material, the at least one cryptographic technique, and the shared key associated with the data to restrict the one or more receivers from accessing the data. In an embodiment, the encryption engine 212 may update the at least one cryptographic material, the at least one cryptographic technique, and the shared key associated with the data to modify an access control for the one or more receivers.

In an embodiment, the transmission engine 212 may receive a request message from the one or more receivers, such as the receiver 104 and may transmit the shared key to the receiver 104 in response to the reception of the request message.

FIG. 2B illustrates exemplary block diagram of a receiver for data decryption, in accordance with an embodiment of the present disclosure.

Referring to block diagram 200B of FIG. 2B, the receiver 104 may include one or more processor(s) 220. The one or more processor(s) 220 may be implemented as one or more microprocessors, microcomputers, microcontrollers, digital signal processors, central processing units, logic circuitries, and/or any devices that manipulate data based on operational instructions. Among other capabilities, the one or more processor(s) 220 may be configured to fetch and execute computer-readable instructions stored in a memory 222. The memory 222 may store one or more computer-readable instructions or routines, which may be fetched and executed to decrypt shared data received over a communication network, such as the network 106. The memory 222 may include any non-transitory storage device including, for example, volatile memory such as RAM, or non-volatile memory such as an EPROM, flash memory, and the like.

In an embodiment, the receiver 104 may also include an interface(s) 224. The interface(s) 224 may include a variety of interfaces, for example, interfaces for data input and output devices, referred to as I/O devices, storage devices, and the like. The interface(s) 224 may also provide a communication pathway for one or more components of the receiver 104. Examples of such components include, but are not limited to, processing engine(s) 226 and a database 234. In some embodiments, the database 234 may store therein data received or generated by the receiver 104. For example, if the receiver 104 is a server, the database 234 may be configured to store received KGM, KDF, encrypted documents, cryptographic hashes, encrypted share points, and file attributes, as well as decrypted documents and reconstructed shared keys. For example, is the receiver is a computing device, the memory 224 may be configured to store received KGM, KDF, encrypted documents, cryptographic hashes, encrypted share points, and file attributes, as well as decrypted documents and reconstructed shared keys.

In an embodiment, the processing engine(s) 226 may be implemented as a combination of hardware and programming to implement one or more functionalities of the receiver 104. In an embodiment, the processing engine(s) 226 may include a receiving engine 228, a decryption engine 230, and other engine(s) 232.

In an embodiment, the one or more processors 220 may transmit the plurality of cryptographic materials and the plurality of cryptographic techniques to the transmitter 102 through the pre-established channels and receive the plurality of cryptographic materials and the plurality of cryptographic techniques from the transmitter 102 through the pre-established channels. Further, the one or more processors 220 may determine that the reception and the transmission of the plurality of cryptographic materials and the plurality of cryptographic techniques are completed and receive the data from the transmitter 102 based on the determination of the reception and the transmission.

In an embodiment, the receiving engine 230 may be configured to receive the data from one or more transmitters, such as the transmitter 102 in response to sending a request message to the transmitter 102 for accessing the data.

In an embodiment, the decryption engine 232 may be configured to determine that the data is received from the transmitter 102 is encrypted with at least one cryptographic material of a plurality of cryptographic materials, at least one cryptographic technique of a plurality of cryptographic techniques and a shared key.

In an embodiment, the decryption engine 232 may further determine an identifier associated with the at least one cryptographic material and the at least one cryptographic technique shared by the transmitter 102 along with the data.

In an embodiment, the decryption engine 232 may generate a dynamic key using the at least one cryptographic technique based on information associated with the at least one cryptographic material by determining the identifier. In an example, the decryption engine 232 may generates the dynamic key by utilizing information extracted from the identifier, which specifies the cryptographic technique and material to be used. The decryption engine 232 may reconstruct the shared key, applying the identified cryptographic technique (such as the KDF) along with additional inputs like timestamps. The process incorporates information from the cryptographic material, including salt values or iteration counts. The symmetric key is subsequently applied to decrypt the received data. In an example, the decryption engine 230 may verify the integrity of the decrypted data by comparing a generated hash of the decrypted data with the received hash.

In an embodiment, the decryption engine 232 may determine a symmetric key based on both the dynamic key and the shared key. The dynamic key may be generated using cryptographic materials and techniques, which add an extra layer of security to the encryption process.

In an embodiment, the decryption engine 232 may determine one or more attributes associated with the data by decrypting the data using the symmetric key.

For example, Alice (e.g., the transmitter 102) may want to send a sensitive document to Bob (e.g., the receiver 104). The transmitter 102 may generate unique KGM (e.g., a specific image) and KDF for Bob. Alice's transmitter 102 may create a shared key and generate a dynamic key using the KGM, and KDF. The document may be encrypted with this symmetric key. Alice's transmitter 102 may also generate a hash of the document. The Alice's transmitter 102 may send the KGM, KDF, encrypted document, document hash to Bob's receiver 104. The Bob's receiver 104 may receive these components. The Bob uses the KGM and KDF to generate the same dynamic key. The Bob's receiver 104 may reconstruct the shared key. Using the symmetric key, Bob's receiver 104 decrypts the document. Bob's decryption system (e.g., 104) may verify the document's integrity by comparing the received hash with a newly generated hash of the decrypted document. If Alice wants to revoke Bob's access, Alice may update or clear the KGM and KDF, making it impossible for Bob to generate the correct the symmetric key for decryption. This ensures that the encryption/decryption keys are never stored but generated dynamically for each use. The data remains encrypted by default and is only decrypted when viewed by an authorized recipient.

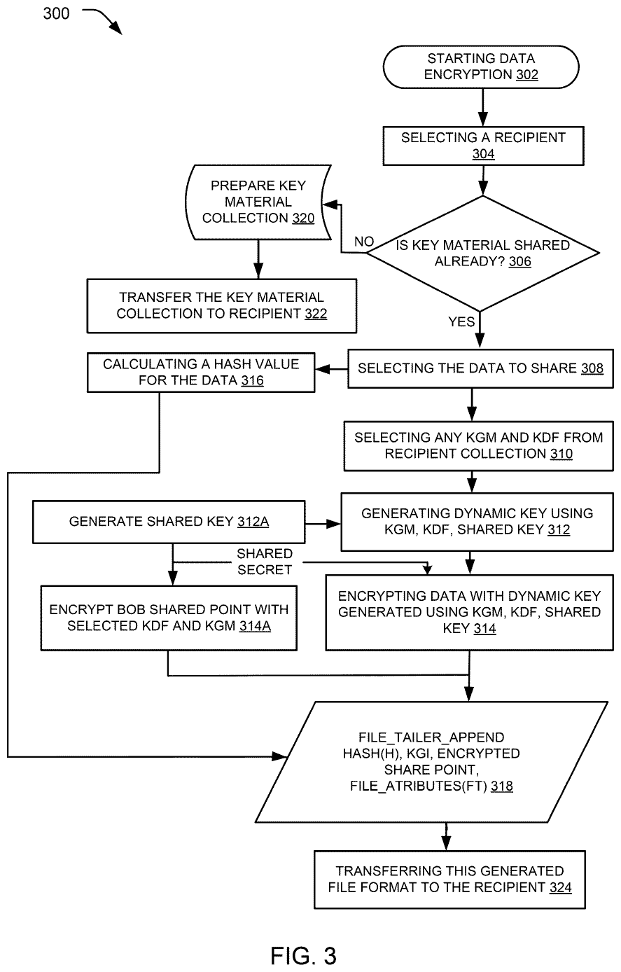

FIG. 3 illustrates a flowchart of an exemplary method 300 for secure data encryption and sharing the encrypted data to the receiver, in accordance with embodiments of the present disclosure. In some embodiments, the method 300 may be implemented by the transmitter 102.

Referring to FIG. 3, at step 302, the encryption process of data, such as a transmission, begins. This may be initiated, for example, by accessing the transmitter 102.

At step 304, the method 300 includes selecting a recipient, such as a receiver 104, for sharing the document. This may involve identifying the intended recipient of the document.

At step 306, the method 300 may include determining if key material has already been shared with the recipient. If it is determined that the key material has been shared, the method proceeds to step 308.

At step 308, the method 300 includes selecting the document to be shared with the recipient.

At step 310, the method 300 includes selecting any KGM and KDF from the recipient collection. These elements are to be used in the encryption process.

At step 312, the method 300 may include generating a dynamic key using the KGM, and the KDF. In an example, the shared key may be generated and shared for encrypting process as represented at 312A.

At step 314, the method 300 may include encrypting the document using the generated dynamic key generated using the KGM, and the KDF. In an embodiment, the receiver (e.g., 104) shared point is encrypted with the selected KDF and the KGM.

At step 316, the method 300 includes calculating a hash value for the document that is to be shared, which may be used for integrity verification of the encrypted document.

At step 318, the method 300 may include appending the file tailer with the hash, Key Generation Information (KGI), encrypted share point, and file attributes.

However, at the step 306, it is determined that the key material has not been shared, the method 300 may proceed to step 320.

At step 320, the method 300 may include preparing a key material collection, which may include various forms of key material such as images, audio, and video.

At step 322, the method 300 may include receiving the prepared key material collection to the recipient. This ensures the recipient has the necessary materials for decryption. Subsequently, the method 300 continues with the steps following step 308 as previously described.

At step 324, the method 300 may include transferring to the recipient, the generated file format, including the encrypted data, hash, and necessary cryptographic information, is transferred to the recipient.

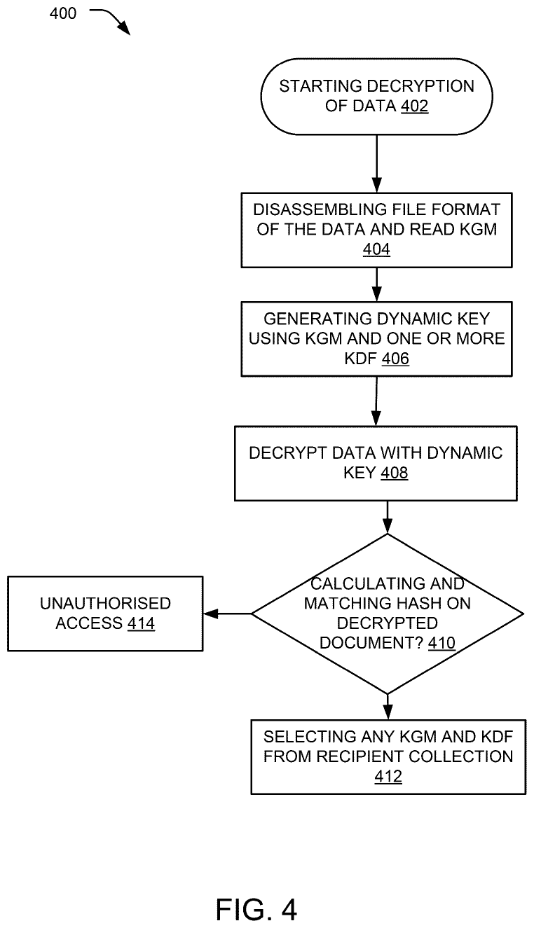

FIG. 4 illustrates a flowchart of an exemplary method 400 for decrypting the data received from the transmitter (e.g., 102), in accordance with embodiments of the present disclosure. In some embodiments, the method 400 may be implemented by the receiver 104.

Referring to FIG. 4, at step 402, the method 400 includes initiation of the data decryption, for example, by receiving the encrypted data, which in an example, may be a document, from the transmitter 102.

At step 404, the method 400 includes disassembling the file format of the data and read the KGM. At this step, the receiver 104 may disassemble the file format of the encrypted data to extract the KGM. The KGM may be used to create a dynamic key, which may be later be used for the decryption.

At step 406, the method 400 includes generating a dynamic key using the KGM and one or more KDFs. At this step, the receiver 104 may generate the dynamic key by combining the extracted KGM with one or more KDFs.

At step 408, the method 400 include decrypting the document with symmetric key. The receiver 104 may uses the dynamically generated key to decrypt the document. The encrypted data is unlocked, making it readable and accessible for further validation and processing.

At step 410, the method 400 includes calculating and matching the hash value on the decrypted document. Once the data has been decrypted, the receiver 104 may calculates the hash value for the decrypted document. This hash value may then be compared with the hash value that was sent along with the original encrypted data. If the hash values match, it confirms that the decrypted data is intact and has not been tampered with. If the hash matches, the method 400 continues to the next step.

At step 412, the method 400 includes selecting any KGM and KDF from the recipient collection. If the hash values match, confirming the integrity of the data, the receiver 104 proceeds to select a new KGM and KDF from the recipient's collection. This selection may be part of a process to secure subsequent communications or further interactions.

However, if the hash values do not match, the receiver 104 may flag the event as unauthorized access, indicating that the data may have been compromised or altered. If the receiver 104 detects a mismatch in the hash values, it determines that there has been unauthorized access as represented at 414. This step terminates the process, preventing the recipient from accessing the data due to security concerns.

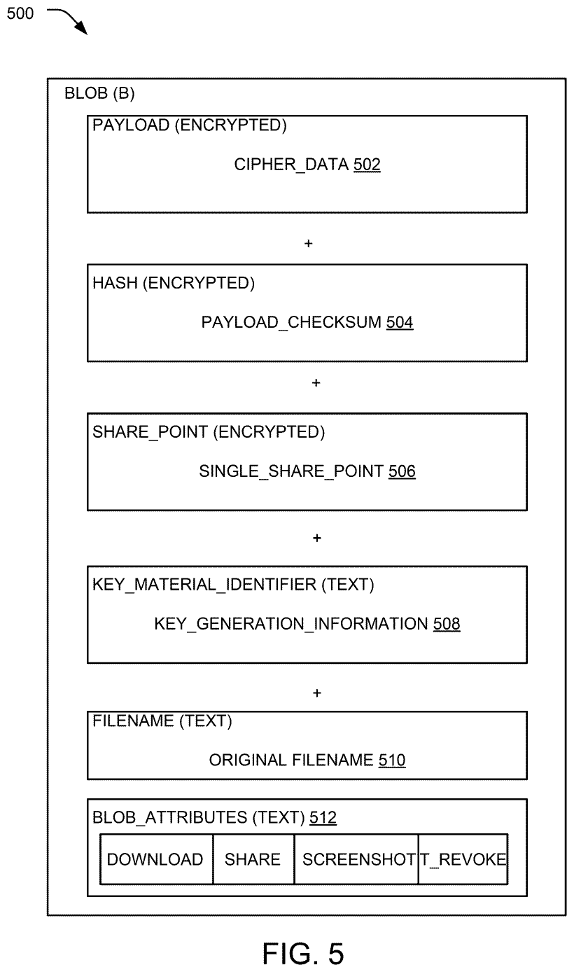

FIG. 5 illustrated an exemplary representation 500 of a structure of outgoing data from the transmitter 102 to the receiver 102, in accordance with embodiments of the present disclosure.

In an embodiment, the data, referred to as a “blob” in the FIG. 5 because it encapsulates all the essential components required for secure transmission, decryption, and controlled access of the data between the transmitter 102 and the receiver 104, may be transmitted as a payload (encrypted), which contains the cipher_data 502. This refers to the actual data that has been encrypted and is being transmitted. The encryption ensures that the data is secure during transmission, preventing unauthorized entities from reading or tampering with it. The payload may contain the content being transferred from the transmitter 102 to the receiver 104. In an example, the cipher_data 502 may be encrypted using, a dynamic key generated by combining Key Generation Materials (KGM) and a Key Derivation Function (KDF). The dynamic key includes contributions from a shared key, which consists of a “source part of key” and a “peer part of key” along with other cryptographic materials. In an example, the “source part of key” may refer to the portion of the cryptographic key that is generated and retained by the sender (or owner of the data) during the encryption process. The “peer part of key” may correspond to the portion of the key that is held by the receiver (or intended recipient).

In an embodiment, the next component of the blob may be a hash (encrypted), labeled as payload_checksum 504. This hash value is essentially a cryptographic checksum of the encrypted data in the payload. The hash value ensures the integrity of the data by allowing the receiver 104 to verify that the payload has not been altered or corrupted during transmission. If any tampering or errors occur, the hash values calculated on both ends (transmitter 102 and receiver 104) may not match, indicating data corruption or unauthorized interference. In an example, the payload_checksum may be encrypted using the same dynamic key, which is generated with “source part of key” and the “peer part of key”, ensuring data integrity.

In an embodiment, the blob may further include a shared key that, is represented as single_share_point 506. This shared key corresponds to the division of the encryption key into multiple “shares,” with each share distributed to different parties. The shared key can only be reconstructed when a sufficient number of shares are combined. In this case, the single_share point 506 represents one such share being transmitted to the receiver 104, enabling the receiver 104 to contribute to the reconstruction of the original shared key when multiple shares are required. In an example, the single_share point may be encrypted with the dynamic key, which also leverages “source part of key” and the “peer part of key” for enhanced security.

In an embodiment, the blob may contain Key Material Identifier (KPI) 508. The KPI include information about the cryptographic key material used for encryption. This includes key generation information that helps the receiver 104 understand how the encryption key is generated. The KPI ensures that the receiver 104 may regenerate or verify the key using the same parameters and cryptographic functions that were used during the encryption process by the transmitter 102. The KPI ensures consistency and security in the key exchange process. This key generation information may remain in plain text to allow the receiver 104 to access to the key parameters and configuration.

In an embodiment, the blob may further include the filename (text) 510, which specifies the original name of the file or digital asset being transmitted. This filename provides clarity and context for the receiver 104 regarding the content being accessed or retrieved. Including the filename ensures that the receiver may properly identify and manage the received data, allowing for easier organization and retrieval. The filename may remain in plain text to facilitate quick reference without requiring decryption, thereby improving user experience.

In an embodiment, the blob may also include Blob Attributes (BT) 512, which may define the access control options for the data. These attributes may control how the receiver 104 may interact with the data. The attributes may include, but is not limited to, download, share, screenshot, T_Revoke (time-based revocation to access the data) which may represents a time-based revocation option, which defines when or if the data can be revoked, meaning access may be restricted or terminated after a certain period. In an example, the blob attributes may remain in plain text to facilitate access control options.

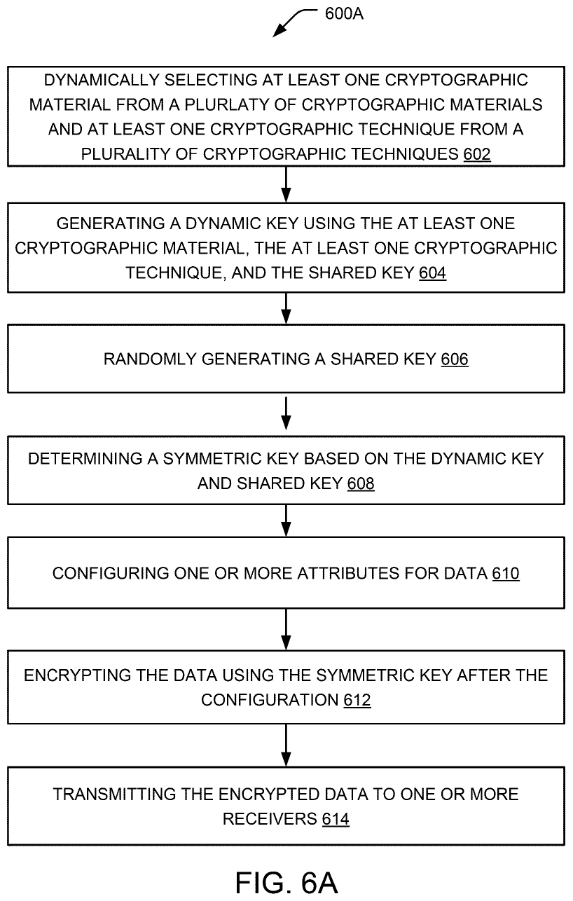

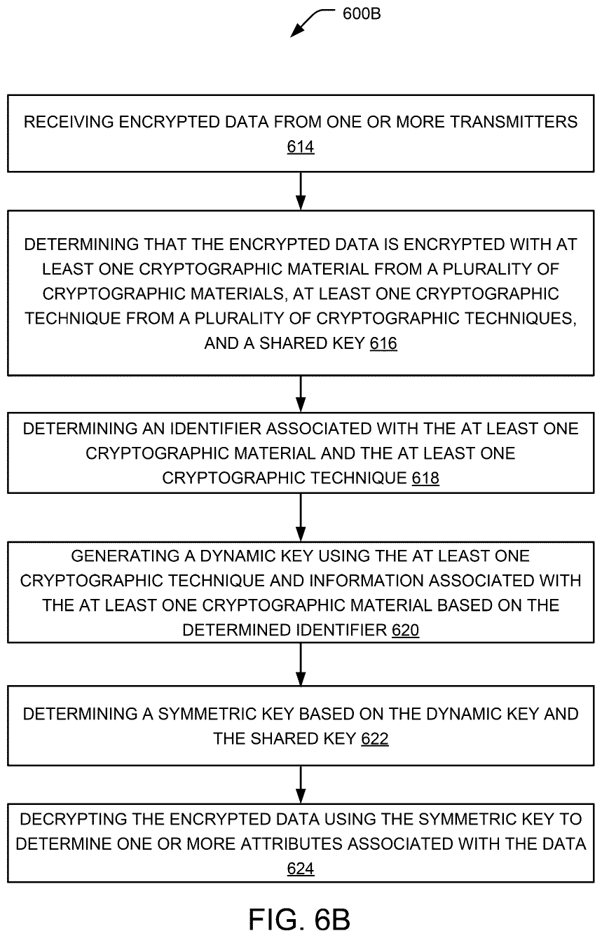

FIG. 6A illustrates a flow chart of an example method 600A for data encryption, in accordance with embodiments of the present disclosure. In some embodiments, the method 600A may be implemented by the transmitter 102.

Referring to FIG. 6A, at step 602, the method 600A may include dynamically selecting, by one or more processors 202 associated with the transmitter 102, at least one cryptographic material from a plurality of cryptographic materials and at least one cryptographic technique from a plurality of cryptographic techniques.

At step 604, the method 600A may include generating, by the one or more processors 202, a dynamic key using the plurality of cryptographic materials, the at least one cryptographic technique, and the shared key.

At step 606, the method 600A may include randomly generating, by the one or more processors 202, a shared key.

At step 608, the method 600A may include determining, by the one or more processors 202, a symmetric key based on the dynamic key and the shared key.

At step 610, the method 600A may include configuring, by the one or more processors 202, one or more attributes for data that is to be shared.

At step 612, the method 600A may include encrypting, by the one or more processors 202, the data using the symmetric key after the configuration.

At step 614, the method 600A may include transmitting, by the one or more processors 202, the encrypted data to one or more receivers, such as the receiver 104.

FIG. 6B illustrates a flow chart of an example method 600B for data decryption, in accordance with embodiments of the present disclosure. In some embodiments, the method 600B may be implemented by the receiver 104.

Referring to FIG. 6B, at step 614, the receiving method 600B for data decryption may include receiving, by one or more processors 220 associated with the receiver 104, encrypted data from one or more transmitters, such as the transmitter 102.

At step 616, the receiving method 600B includes determining, by the one or more processors 220, that the data is encrypted with at least one cryptographic material of a plurality of cryptographic materials, at least one cryptographic technique of a plurality of cryptographic techniques, and a shared key.

At step 618, the receiving method 600B also includes determining, by the one or more processors 220, an identifier associated with the at least one cryptographic material and the at least one cryptographic technique.

At step 620, the receiving method 600B includes generating, by the one or more processors 220, a dynamic key using the at least one cryptographic technique based on information associated with the at least one cryptographic material by determining the identifier.

At step 622, the receiving method 600B includes, determining, by the one or more processors 220, a symmetric key based on the dynamic key and the shared key

At step 624, the receiving method 600B includes decrypting, by the one or more processors 220, the encrypted data using the symmetric key to determine one or more attributes associated with the data.

Therefore, the present invention allows secure data sharing while maintaining full control over the shared data, even after it has been transmitted. The shared data remains protected as the receiver never possesses the encryption or decryption key directly. Instead, they dynamically generate keys using the KGM and the KDF. Furthermore, a distributed key system involving multiple parties requires each party to contribute, ensuring security. All encryption and decryption operations occur within a secure environment called a “secure enclave,” which handles cryptographic operations without exposing the underlying keys or intermediate data.

A secure enclave is a protected system, either in hardware or software that safely manages cryptographic keys. This system ensures that only the final encrypted or decrypted output is exposed, maintaining the confidentiality of the data during processing. The innovation uses end-to-end encryption, with both the sender and receiver dynamically generating symmetric keys to encrypt and decrypt messages, thereby removing dependence on either party's system security and providing the data owner with complete control over access.

For example, when Alice sends a message to Bob, the data is encrypted with dynamically generated keys using KGMs and KDFs. Bob must generate the dynamic key to decrypt the message. If Bob attempts to share Alice's data without permission, he will be unable to, as the dynamic key generation process requires Alice's input. Additionally, the secret-sharing method ensures that no single entity can independently reconstruct the key without cooperation from all required participants, thus enhancing security.

Even though Alice and Bob use a secure system, all operations take place within a hardware-or software-assisted secure enclave, sandbox, or isolated container. This ensures that third-party applications cannot access or interfere with the communication protocol or data. Even if someone gains access to Alice or Bob's devices, the data remains encrypted at all times due to this added layer of security. The method addresses key issues by ensuring that encryption and decryption keys are never stored but dynamically generated. Data remains encrypted by default, requiring decryption for access, which ensures that files and documents are always secure unless authorized. Regular key rotation further strengthens security, and the encryption and decryption handshake occurs within the secure enclave, providing an extra layer of protection.

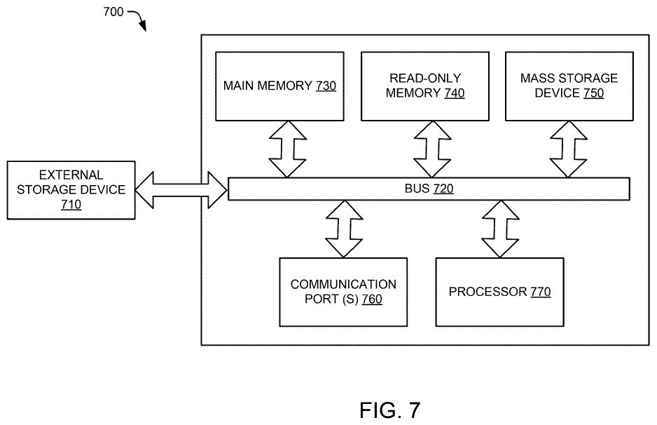

Referring to FIG. 7, the block diagram represents a computer system 700 that includes an external storage device 710, a bus 720, a main memory 730, a read only memory 740, a mass storage device 750, a communication port 760, and a processor 770. A person skilled in the art will appreciate that the computer system 700 may include more than one processor 770 and communication ports 760. The processors 770 may include various modules associated with embodiments of the present disclosure. The communication port(s) 760 may be any of a recommended standard 232 port for use with a modem-based dialup connection, a 10/100 Ethernet port, a Gigabit or 10 Gigabit port using copper or fiber, a serial port, a parallel port, or other existing or future ports. The communication port(s) 760 may be chosen depending on a network, such as a Local Area Network (LAN), a Wide Area Network (WAN), or any network to which computer system 700 connects. In an embodiment, the main memory 730 can be a RAM, or any other dynamic storage device commonly known in the art. The Read-Only Memory (ROM) 470 may be any static storage device(s) e.g., but not limited to, a Programmable Read-Only Memory (PROM) chip for storing static information. The mass storage 450 may be any current or future mass storage solution, which may be used to store information and/or instructions. Exemplary mass storage solutions may include, but are not limited to, Parallel Advanced Technology Attachment (PATA) or Serial Advanced Technology Attachment (SATA) hard disk drives or solid-state drives (internal or external, e.g., having Universal Serial Bus (USB) and/or Firewire interfaces), one or more optical discs, Redundant Array of Independent Disks (RAID) storage, e.g., an array of disks (e.g., SATA arrays).

In an embodiment, the bus 720 communicatively couples the one or more processors(s) 770 with the other memory, storage, and communication blocks. The bus 720 may be, e.g., a Peripheral Component Interconnect (PCI) / PCI Extended (PCI-X) bus, Small Computer System Interface (SCSI), USB, or the like, for connecting expansion cards, drives, and other subsystems as well as other buses, such as front side bus (FSB), which connects the processors 770 to the computer system 700.

In another embodiment, operator and administrative interfaces, e.g., a display, keyboard, and a cursor control device, may also be coupled to the bus 720 to support direct operator interaction with computer system 700. Other operator and administrative interfaces may be provided through network connections connected through communication port 760. In some embodiments, the external storage device 710 may be any kind of external hard-drives, floppy drives, Compact Disc Read Only Memory (CD-ROM), Compact Disc-Re-Writable (CD-RW), Digital Video Disk-Read Only Memory (DVD-ROM). Components described above are meant only to exemplify various possibilities. In no way should the aforementioned exemplary computer system 700 limit the scope of the present disclosure.

While the foregoing describes various embodiments of the present disclosure, other and further embodiments of the present disclosure may be devised without departing from the basic scope thereof. The scope of the present disclosure is determined by the claims that follow. The present disclosure is not limited to the described embodiments, versions or examples, which are included to enable a person having ordinary skill in the art to make and use the present disclosure when combined with information and knowledge available to the person having ordinary skill in the art.

### Advantages of the Present Disclosure

The present disclosure enhances data security and privacy by implementing a dynamic key generation system, ensuring that encryption keys are never stored or transmitted, thus significantly reducing the risk of unauthorized access to sensitive information.

The present disclosure improves data owner control by allowing the originator to set specific access permissions, such as enabling or disabling downloads, forwarding, and screenshots, as well as implementing time-based or on-demand revocation of access, thereby maintaining control over shared data even after it has been transmitted.

The present disclosure provides increased protection against data breaches by utilizing a combination of Key Generation Material (KGM), Key Derivation Functions (KDF), and shared secrets to create unique, one-time-use dynamic keys for each document or message, making it extremely difficult for attackers to compromise multiple pieces of data even if one is intercepted.

The present disclosure facilitates a proactive approach to data security through regular updates of the KGMs and the KDFs, ensuring that the encryption system remains robust and adaptable to emerging threats, thus providing long-term protection for sensitive information.

The present disclosure improves the integrity and authenticity of shared data by implementing cryptographic hashing and checksum verification, allowing recipients to confirm that the received data has not been tampered with during transmission or storage.

The present disclosure enhances overall system security by performing all cryptographic operations within a secure enclave or trusted execution environment, protecting the encryption and decryption processes from potential attacks or unauthorized access, even if the device itself is compromised.

We claim:

1. A transmitter for data encryption, the transmitter comprising:
one or more processors; and
a memory operatively coupled to the one or more processors, wherein the memory comprises processor-executable instructions, which, when executed, cause the one or more processors to:
dynamically select at least one cryptographic material from a plurality of cryptographic materials and at least one cryptographic technique from a plurality of cryptographic techniques;
generate a dynamic key using the at least one cryptographic material, and the at least one cryptographic techniques;
randomly generate a shared key;
determine a symmetric key based on the dynamic key and the shared key;
configure one or more attributes for data;
encrypt the data using the symmetric key after the configuration; and
transmit the encrypted data to one or more receivers.

2. The transmitter of claim 1, wherein the one or more processors are further configured to:
transmit the plurality of cryptographic materials and the plurality of cryptographic techniques to the one or more receivers through one or more pre-established channels;
receive the plurality of cryptographic materials and the plurality of cryptographic techniques from the one or more receivers through the one or more pre-established channels; and
dynamically select the at least one cryptographic material and the at least one cryptographic technique upon the reception and the transmission of the plurality of cryptographic materials and the plurality of cryptographic techniques is completed.

3. The transmitter of claim 1, wherein the one or more attributes comprise at least one of: options for enabling or disabling download, options for permitting or blocking the data to share with one or more another receivers, or options for permitting or blocking snapshots of the data, time-based data revocation.

4. The transmitter of claim 1, wherein the one or more processors are further configured to:
generate a hash value associated with the data; and
transmit the hash value along with the encrypted data to the one or more receivers.

5. The transmitter of claim 1, wherein the one or more processors are further configured to:
transmit an identifier associated with the at least one cryptographic material and the at least one cryptographic techniques along with the encrypted data to the one or more receiver.

6. The transmitter of claim 1, wherein the one or more processors are further configured to:
remove the at least one cryptographic material, the at least one cryptographic technique, and the shared key associated with the data to restrict the one or more receivers from accessing the data.

7. The transmitter of claim 1, wherein the one or more processors are further configured to:
update the at least one cryptographic material, the at least one cryptographic technique, and the shared key associated with the data to modify an access control for the one or more receivers.

8. The transmitter of claim 1, wherein the one or more processors are further configured to:
receive a request message from the one or more receivers; and
transmit the shared key to the one or more receivers in response to the reception of the request message.

9. A receiver for data decryption, the receiver comprising:
one or more processors; and
a memory operatively coupled to the one or more processors, wherein the memory comprises processor-executable instructions, which, when executed, cause the one or more processors to:
receive data from one or more transmitters;
determine that the data are encrypted with at least one cryptographic material of a plurality of cryptographic materials, at least one cryptographic technique of a plurality of cryptographic techniques and a shared key;
determine an identifier associated with the at least one cryptographic material and the at least one cryptographic technique;
generate a dynamic key using the at least one cryptographic technique based on information associated with the at least one cryptographic material by determining the identifier;
determine a symmetric key based on the dynamic key and the shared key; and
decrypting the encrypted data using the symmetric key to determine one or more attributes associated with the data.

10. The receiver of claim 9, wherein the one or more processors are further configured to:
transmit the plurality of cryptographic materials and the plurality of cryptographic techniques to the one or more transmitters through one or more pre-established channels;
receive the plurality of cryptographic materials and the plurality of cryptographic techniques from the one or more transmitters through the one or more pre-established channels;
determine that the reception and the transmission of the plurality of cryptographic materials and the plurality of cryptographic techniques are completed; and
receive the data from the one or more transmitters based on the determination of the reception and the transmission.

11. The receiver of claim 9, wherein the one or more attributes comprise at least one of: options for enabling or disabling download, options for permitting or blocking the data to share with one or more another receivers, or options for permitting or blocking snapshots of the data, time-based data revocation.

12. The receiver of claim 9, wherein the one or more processors are further configured to:
generate a hash value associated with the data; and
compare the generated hash value with the hash value received from the one or more transmitters for validation.

13. The receiver of claim 9, wherein the one or more processors are further configured to:
transmit a request message to the one or more transmitters; and
receive the shared key in response to the transmission of the request message for decrypting the data.

14. A method for data encryption, the method comprising:
dynamically selecting, by one or more processors associated with a transmitter, at least one cryptographic material from a plurality of cryptographic materials and at least one cryptographic technique from a plurality of cryptographic techniques;
generating, by the one or more processors, a dynamic key using the at least one cryptographic material, and the at least one cryptographic technique;
randomly generating, by the one or more processors, a shared key;
determining, by the one or more processors, a symmetric key based on the dynamic key and the shared key;
configuring, by the one or more processors, one or more attributes for data;
encrypting, by the one or more processors, the data using the symmetric key after the configuration; and
transmitting, by the one or more processors, the encrypted data to one or more receivers.

15. A method for data decryption, the method comprising:
receiving, by one or more processors associated with a receiver, encrypted data from one or more transmitters;
determining, by the one or more processors, that the data are encrypted with at least one cryptographic material of a plurality of cryptographic materials, at least one cryptographic technique of a plurality of cryptographic techniques, and a shared key;
determining, by the one or more processors, an identifier associated with the at least one cryptographic material and the at least one cryptographic technique;
generating, by the one or more processors, a dynamic key using the at least one cryptographic technique based on information associated with the at least one cryptographic material by determining the identifier;
determining, by the one or more processors, a symmetric key based on the dynamic key and the shared key; and
decrypting, by the one or more processors, the encrypted data using the symmetric key to determine one or more attributes associated with the data.
